(19) United States
(12) Patent Application Publication
(10) Pub. No.: US 2012/0081721 A1
(43) Pub. Date: Apr. 5, 2012

(54) MULTI-FUNCTION PRINTER AND METHOD OF GENERATING PRINT DATA

(76) Inventor: Lianshan ZHU, Hsinchu (TW)

(21) Appl. No.: 13/231,378

(22) Filed: Sep. 13, 2011

(30) Foreign Application Priority Data
Oct. 5, 2010 (TW) 099133785

(51) Int. Cl. H04N 1/60

(52) U.S. Cl. 358/1.9

(57) ABSTRACT

In a multi-function printer, a scanning module reads an image of an original and generates corresponding color image data. A color converter converts a set of red (R), green (G) and blue (B) values of a pixel of the color image data into a set of cyan (C), magenta (M) and yellow (Y) values, and converts one of the two sets of values into a black (K) value. A pattern generator generates first to third sets of patterns according to the C, M and Y values, respectively. A print data generator processes the first to third sets of patterns and the K value into print data. A printing module receives the print data and prints the first to third sets of patterns on a medium in a superimposed manner. The first to third sets of patterns printed are monochrome images having darkness based on the K value.

This application claims priority of No. 099133785 filed in Taiwan R.O.C. on Oct. 5, 2011 under 35 USC 119, the entire content of which is hereby incorporated by reference.

### BACKGROUND OF THE INVENTION

1. Field of the Invention

The present invention relates to a multi-function printer and a method of generating print data, and more particularly to a multi-function printer for converting a color image into a monochrome image having different print patterns for different colors, and a method of generating the print data.

2. Related Art

Three primary colors of light include red, green and blue. Properly adjusting the intensities of the three light beams can make the human being sense almost all the colors. Therefore, an image acquisition device, such as a scanner or a camera, acquires a color image to generate the data represented by the values of the three primary colors.

Regarding the printing of the color image, the properties of the pigments are just contrary to those of the light beams because the pigments absorb the light beams and are not for enhancing the light beams. Thus, the three primary colors of the pigments, also referred to as printing primary colors, cyan, magenta and yellow, are the complementary colors of red, green and blue and individually absorb the red, green and blue colors, and are measured by its concentration ranging from 0 to 100%. Theoretically, after the pigments with the three printing primary colors are mixed, red, green and blue light beams should be completely absorbed by the mixed pigment to obtain the black. However, it is impossible to find in real life the pigment which completely absorbs or reflects light. In fact, the mixed pigment still reflects some light beams and appears in the color of dark gray or dark brown. In order to solve this problem, a black pigment is added and magenta and yellow printing plates are aligned with the key of the black. The “K” in CMYK stands for the key of the black. Therefore, the so-called CMYK color model is adopted.

When the conventional mono printer is printing color images, for each pixel of the color images, the red (R) value, the green (G) value and the blue (B) value of the pixel are directly converted into a black (K) value, and the printed pattern corresponding to this pixel is generated according to the K value. However, the conventional mono printer is not able to successfully produce the print patterns for all colors, for example, the yellow color.

Therefore, the present invention provides a multi-function printer and a method of generating print data, in which the monochrome print images produced can accurately translate the image colors.

### SUMMARY OF THE INVENTION

Accordingly, the present invention has been proposed to solve the problems of the prior art, and it is an object of the present invention to provide a multi-function printer and a method of generating print data. In the present invention, red (R), green (G) and blue (B) values of a pixel are converted into cyan (C), magenta (M), yellow (Y) and black (K) values, and monochrome images with interlaced patterns are generated according to these values.

To achieve the above-identified object, the present invention provides a multi-function printer including a scanning module, an image processing unit, a print data generator and a printing module. The scanning module reads an image of an original and generates corresponding color image data. The image processing unit processes the color image data and includes a color converter and a pattern generator. The color converter converts a set of red (R), green (G) and blue (B) values of a pixel of the color image data into a set of cyan (C), magenta (M) and yellow (Y) values, and converts one of the set of the red (R), green (G) and blue (B) values and the set of the cyan (C), magenta (M) and yellow (Y) values into a black (K) value. The pattern generator generates a first pattern, a second pattern and a third pattern according to the cyan (C) value, magenta (M) value and yellow (Y) value, respectively. The print data generator processes the first pattern, the second pattern, the third pattern and the black (K) value into print data. The printing module receives the print data and prints the first pattern, the second pattern and the third pattern of the print data on a medium in a superimposed manner, wherein the patterns are monochrome images having darkness based on the black (K) value.

The present invention further provides a method of processing color image data into print data. The method includes the steps of: (a) converting a set of red (R), green (G) and blue (B) values of a pixel of the color image data into a set of cyan (C), magenta (M) and yellow (Y) values; (b) converting one of the set of the red (R), green (G) and blue (B) values and the set of the cyan (C), magenta (M) and yellow (Y) values into a black (K) value; (c) generating a first pattern, a second pattern and a third pattern according to the cyan (C) value, magenta (M) value and yellow (Y) value, respectively; and (d) processing the first pattern, the second pattern, the third pattern and the black (K) value into the print data.

According to the present invention, each pixel of the generated print data is constituted by multiple patterns. The area ratios and the colors of these patterns are determined by the cyan value, the magenta value, the blue value and the black value. Thus, in the monochrome print image, each color of the color image may be represented by a distinct graphical design having darkness determined by the black (K) value, and the colors which have been misrepresented in the print image produced by the conventional printer can be properly displayed in the monochrome print image according to the present invention.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

FIG. 1A is a pictorial view of a multi-function printer according to the present invention.

FIG. 1B is a functional block diagram of the multi-function printer according to the present invention.

FIG. 2 is a functional block diagram of a color converter of FIG. 1B.

FIGS. 3 and 4 show two examples of color converters.

FIGS. 5 and 6 show two examples of first to third patterns.

FIG. 7 is a schematic illustration of the first to third patterns of FIG. 6 printed on a medium in a superimposed manner.

FIG. 8 is a flow chart of a method of generating print data according to the present invention.

### DETAILED DESCRIPTION OF THE INVENTION

The present invention will be apparent from the following detailed description, which proceeds with reference to the accompanying drawings.

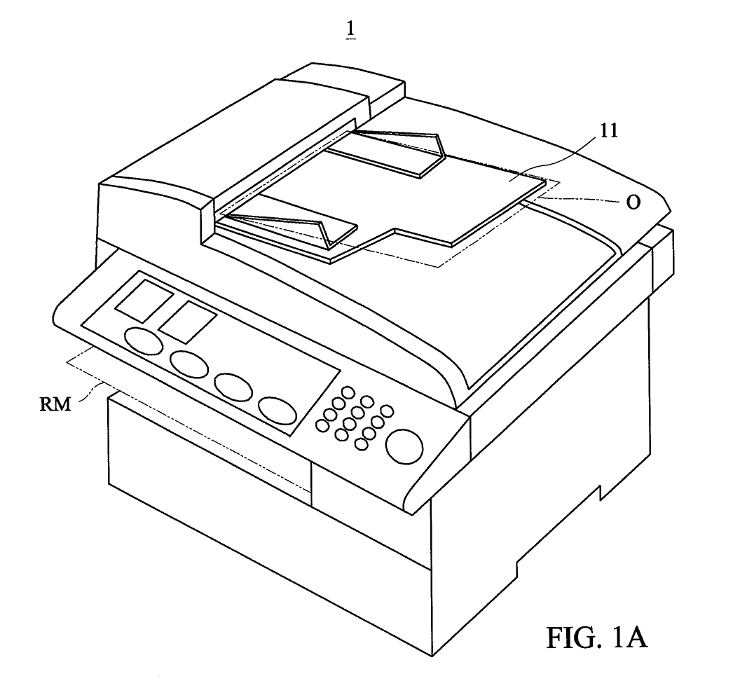

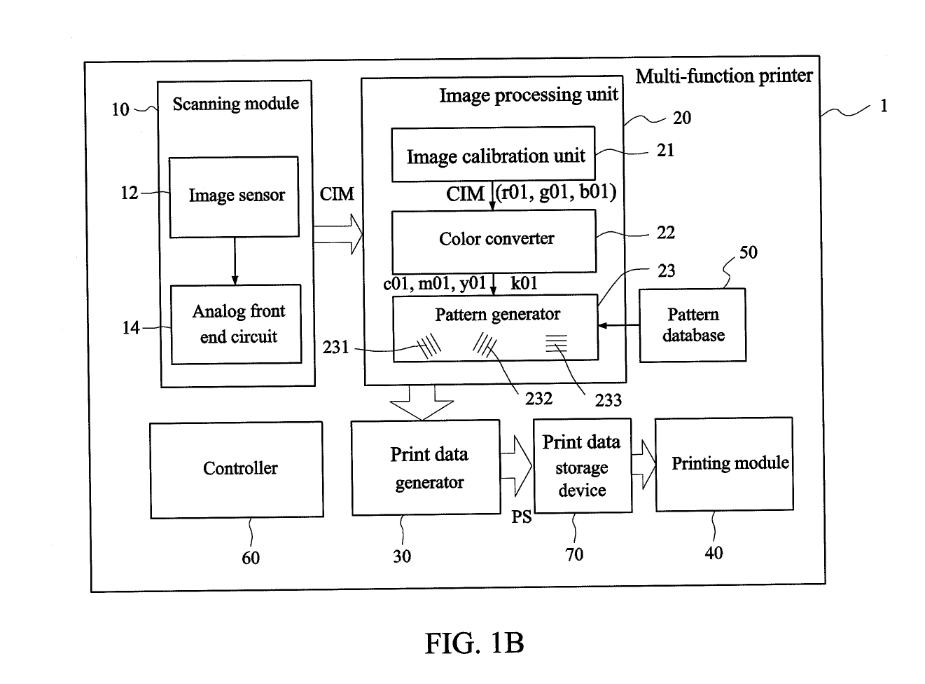

FIG. 1A is a pictorial view of a multi-function printer 1 according to the present invention. FIG. 1B is a functional block diagram of the multi-function printer 1 according to the present invention. Referring to FIGS. 1A and 1B, the multi-function printer 1 includes a scanning module 10, an image processing unit 20, a print data generator 30 and a printing module 40. In addition, the multi-function printer 1 further includes a pattern database 50, a controller 60 and a print data storage device 70. The controller 60 controls the operations of the scanning module 10, the image processing unit 20, the print data generator 30, the printing module 40, and the print data storage device 70.

The scanning module 10 reads an image of an original O, and generates corresponding color image data CIM. Specifically speaking, the scanning module 10 has an image sensor 12 for reading the image of the original O and then obtaining an analog signal, and an analog front end circuit 14 which performs analog-to-digital conversion on the analog signal and therefore produces the color image data CIM. In FIG. 1A, the original O is placed in a supply tray 11 and is transported past the scanning module 10, which reads the image of the original O. However, the original O may also be placed on a scan platen through which the scanning module 10 reads the image of the original O.

The image processing unit 20 for processing the color image data CIM includes a color converter 22 and a pattern generator 23. In addition, the image processing unit 20 may optionally include an image calibration unit 21 for performing shading correction, gamma correction, compensation and etc.

The color converter 22 converts a set of red (R) value r01, green (G) value g01 and blue (B) value b01 of a pixel of the color image data CIM into a set of cyan (C) value c01, magenta (M) value m01 and yellow (Y) value y01. In addition, the color converter 22 further converts one of the set of red (R) value r01, green (G) value g01 and blue (B) value b01 and the set of cyan (C) value c01, magenta (M) value m01 and yellow (Y) value y01 into a black (K) value k01. Before the color converter 22 converts the red (R) value r01, the green (G) value g01 and the blue (B) value b01 of the pixel of the color image data CIM into the cyan (C) value c01, the magenta (M) value m01 and the yellow (Y) value y01, the red (R) value r0, the green (G) value g0 and the blue (B) value b0 of the pixel may be processed by the color converter 22 and given a weight. For example, the weight coefficients of the primary colors, red (R), green (G) and blue (B), are respectively α=0.3, β=0.6 and γ=0.1, and the red (R) value r0, the green (G) value g0 and the blue (B) value b0 after being weighted become the values r01, g01 and b01.

The pattern generator 23 generates a first pattern 231, a second pattern 232 and a third pattern 233 according to the cyan (C) value c01, magenta (M) value m01 and yellow (Y) value y01, respectively. The pattern database 50 stores data of the first pattern 231, the second pattern 232 and the third pattern 233. For example, the pattern generator 23 generates the first pattern 231, the second pattern 232 and the third pattern 233 using the data in the pattern database 50. It is to be noted that the data stored in the pattern database 50 may be vector data corresponding to each pattern, for example. In this case, the pattern generator 23 determines a first area ratio of the first pattern 231, a second area ratio of the second pattern 232 and a third area ratio of the third pattern 233 according to the cyan (C) value c01, the magenta (M) value m01 and the yellow (Y) value y01, and generates the first pattern 231 with the first area ratio, the second pattern 232 with the second area ratio and the third pattern 233 with the third area ratio, respectively. The first area ratio, second area ratio and third area ratio are proportional to the cyan (C) value, the magenta (M) value and the yellow (Y) value, respectively. In this embodiment, the first pattern 231, the second pattern 232 and the third pattern 233 include three sets of parallel straight lines extending in different directions, and the area ratio represents the ratio of the area covered by the parallel straight lines to the overall area within a range of a pixel. In other words, the higher area ratio corresponds to the thicker straight lines, and the narrower gap between the straight lines. For example, if c01=10, m01=40, y01=60 and k01=25, the third area ratio>the second area ratio>the first area ratio. Thus, the width of the straight line in the third pattern 233 is greater than that of the straight line in each of the second pattern 232 and the first pattern 231.

More particularly, the pattern database 50 may store other graphic groups of patterns, so that the user can choose the pattern from any of the graphic groups for the image to be printed. Therefore, each of the first pattern 231, the second pattern 232 and the third pattern 233 may contain a distinct graphical design. In another example, the pattern database 50 may store graphical pattern data corresponding to different K values.

The print data generator 30 processes the first pattern 231, the second pattern 232, the third pattern 233 and the black (K) value into print data PS. The print data PS may be stored in the print data storage device 70, and may also be directly transferred to the printing module 40 to be printed on the medium.

The printing module 40 is, for example, a printing module for a mono or color laser printer, an ink-jet printer or a dot-matrix printer. The printing module 40 receives the print data PS and prints the first pattern 231, the second pattern 232 and the third pattern 233 of the print data PS on a medium RM in a superimposed manner. The first pattern 231, the second pattern 232 and the third pattern 233 are monochrome images having darkness based on the black (K) value k01. In this embodiment, the printing module 40 prints the first pattern 231, the second pattern 232 and the third pattern 233 based on the color of k01=25. For example, if the black (K) value k01 is greater, the pattern will appear darker in a higher density.

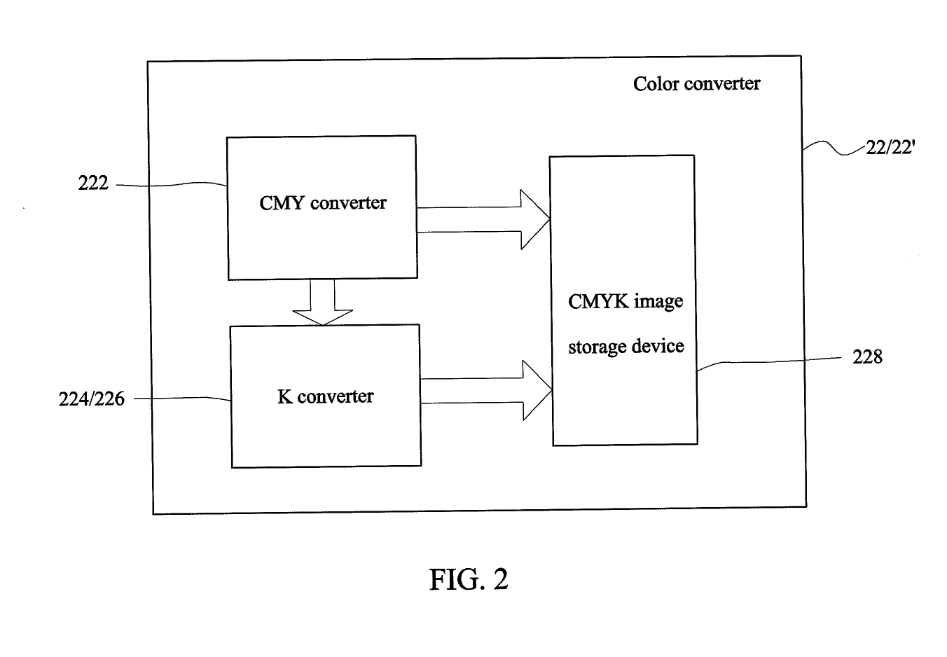

FIG. 2 is a functional block diagram of a color converter 22/22′ of FIG. 1B. Referring to FIG. 2, the color converter 22/22′ includes a CMY converter 222 and a K converter 224/226. In addition, the color converter 22/22′ further includes a CMYK image storage device 228 for storing the image data outputted from the CMY converter 222 and the K converter 224/226.

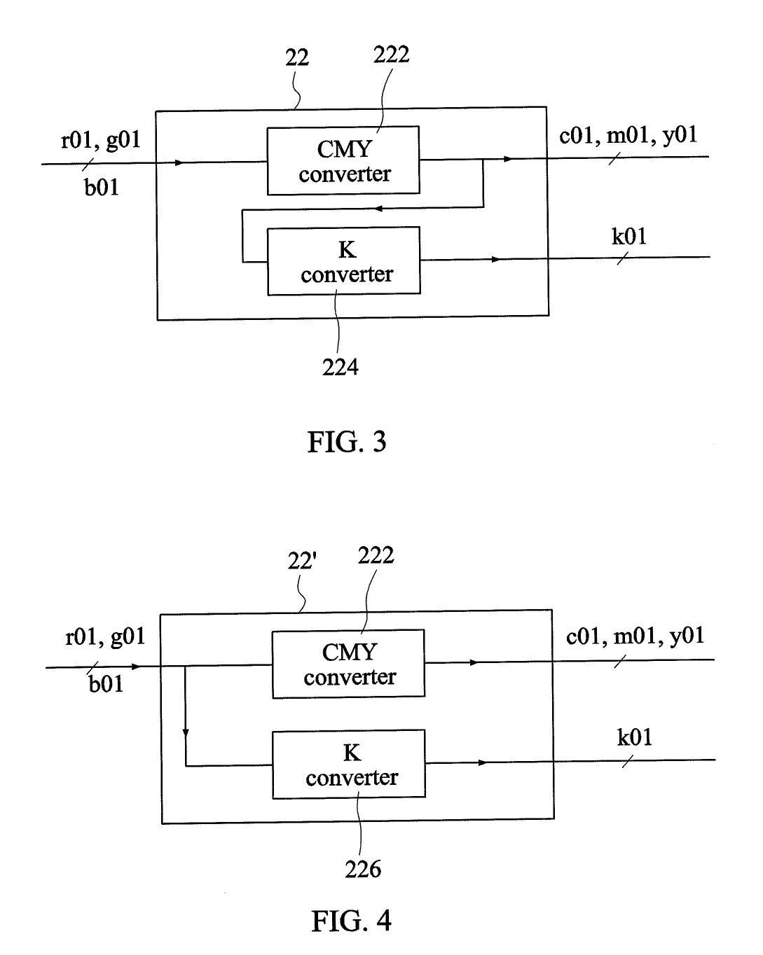

FIGS. 3 and 4 show two examples of color converters. As shown in FIG. 3, the CMY converter 222 converts a set of red (R) value r01, green (G) value g01 and blue (B) value b01 into a set of cyan (C) value c01, magenta (M) value m01 and yellow (Y) value y01. The K converter 224 converts the set of cyan (C) value c01, magenta (M) value m01 and yellow (Y) value y01 into the black (K) value k01, which may be represented by the following function: k01=min(c01, m01, y01), which gives the minimum value of the c01, m01 and y01.

FIG. 4 is similar to FIG. 3 except that the K converter 226 converts the set of red (R) value r01, green (G) value g01 and blue (B) value b01 into the black (K) value k01. The black value k01 may be represented by the following function: k01=f(r01+g01+b01). The black value k01 may further be multiplied by a compensation coefficient “a” to compensate the overlapped portions of the first pattern 231, the second pattern 232 and the third pattern 233, where a 1. Thus, the black (K) value k01 may be generated according to the cyan (C) value c01, the magenta (M) value m01 and the yellow (Y) value y01, or according to the red (R) value r01, the green (G) value g01 and the blue (B) value b01.

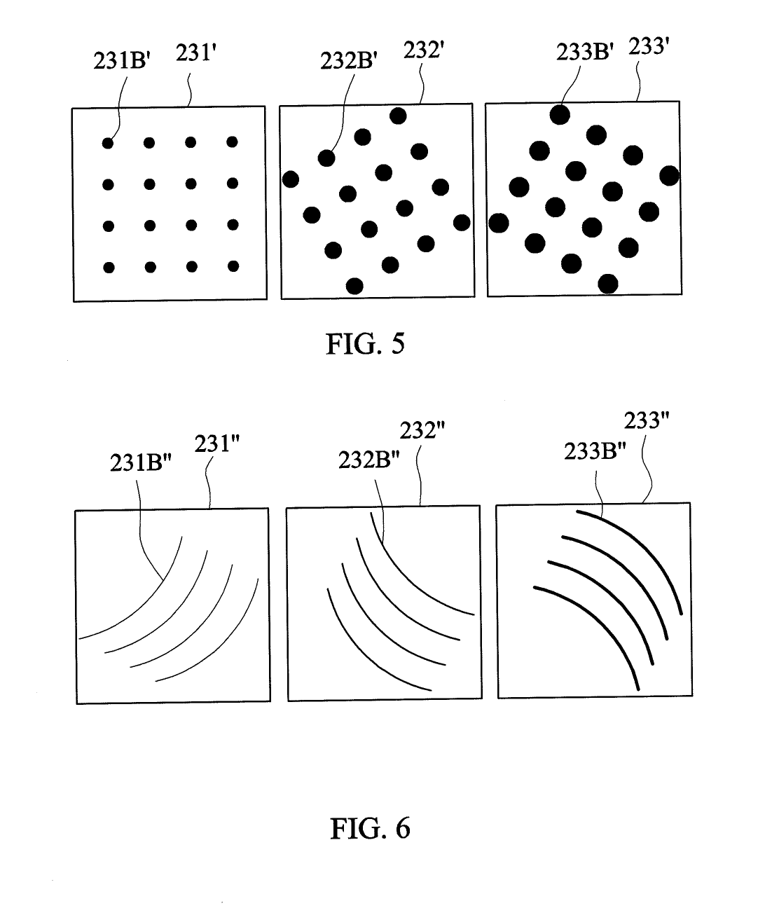

FIGS. 5 and 6 show two examples of first to third patterns. In addition to the straight lines, as shown in FIG. 5, the first pattern 231′, the second pattern 232′ and the third pattern 233′ may contain a plurality of dots 231B′, 232B′ and 233B′, respectively, where 16 dots 231B′ are arranged in a rectangular matrix at an angle of 0 degrees with respect to the horizontal direction, 16 dots 232B′ are arranged in a rectangular matrix at an angle of 120 degrees with respect to the horizontal direction, and 16 dots 233B′ are arranged in a rectangular matrix at an angle of 240 degrees with respect to the horizontal direction. In this embodiment, the higher the area ratio is, the larger are the dots. In the example where c01=10, m01=40 and y01=60, dot 233B′>dot 232B′>dot 231B′.

In another example, the first pattern 231″, the second pattern 232″ and the third pattern 233″ may also include a plurality of curved lines 231B″, 232B″ and 233B″, respectively, as shown in FIG. 6, where the extending directions of the three sets of curved lines 231B″, 232B″ and 233B″ are different from one another. In this embodiment, the higher area ratio is represented by the thicker curved line. That is, the curved line 233B″>the curved line 232B″>the curved line 231B″.

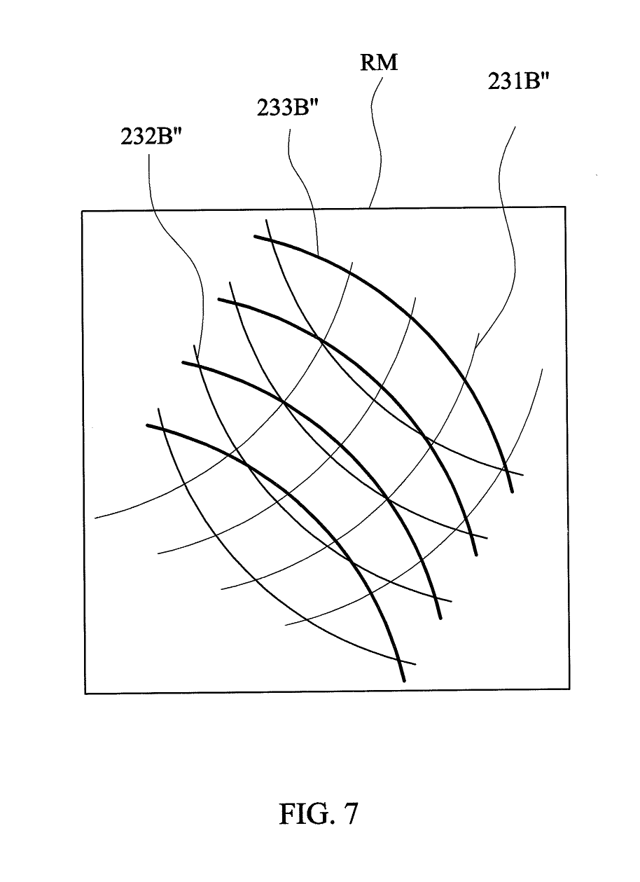

FIG. 7 is a schematic illustration of the first to third patterns 231″ to 233″ of FIG. 6 printed on the medium RM in a superimposed manner.

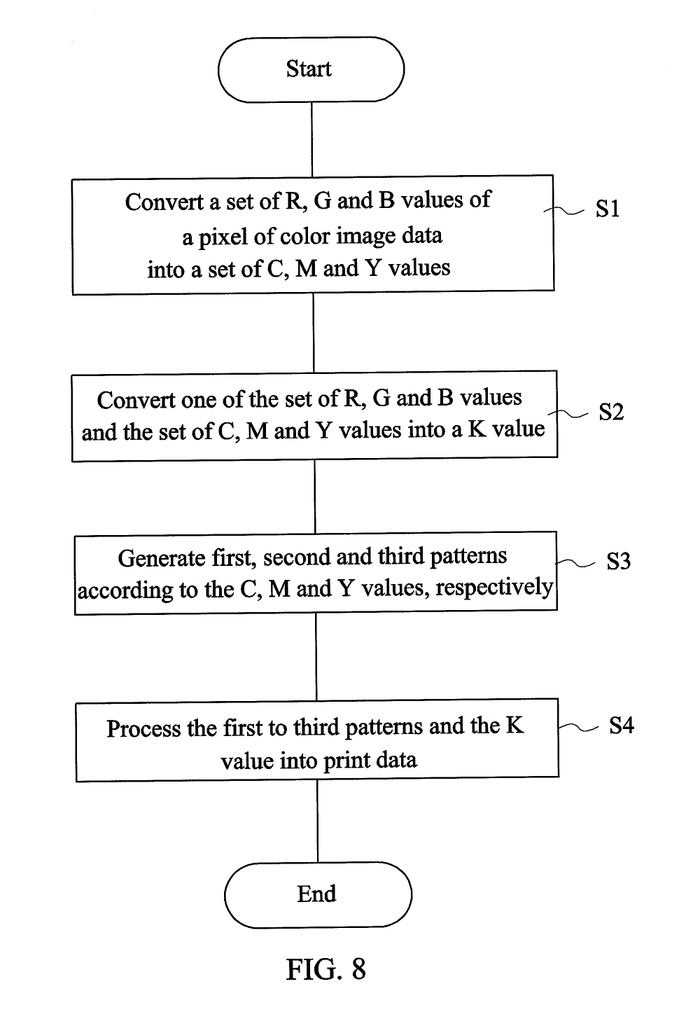

FIG. 8 is a flow chart of a method of generating print data according to the present invention. As shown in FIG. 8, the method of generating the print data according to the present invention may be applied to a multi-function printer, a copier or a printer to process, by hardware or software, the color image data CIM into the print data PS. The method includes the steps that have been described hereinabove. So, these steps are only listed briefly in the following.

First, in step S1, a set of red (R) value, green (G) value and blue (B) value of a pixel of color image data CIM is converted into a set of cyan (C) value, magenta (M) value and yellow (Y) value.

Next, in step S2, one of the set of red (R) value, green (G) value and blue (B) value and the set of cyan (C) value, magenta (M) value and yellow (Y) value is converted into a black (K) value.

Then, in step S3, a first pattern 231, a second pattern 232 and a third pattern 233 are generated according to the cyan (C) value, magenta (M) value and yellow (Y) value, respectively. The details will be described in the following. First, a first area ratio of the first pattern 231, a second area ratio of the second pattern 232 and a third area ratio of the third pattern 233 are determined according to the cyan (C) value, the magenta (M) value and the yellow (Y) value, respectively. Then, the first pattern 231 with the first area ratio, the second pattern 232 with the second area ratio and the third pattern 233 with the third area ratio are generated. Next, in step S4, the first pattern 231, the second pattern 232, the third pattern 233 and the black (K) value are processed into print data PS.

At last, a printing process can be performed to print the print data PS directly. In the printing process, the first pattern 231, the second pattern 232 and the third pattern 233 are printed on the medium RM in a superimposed manner, where the first pattern 231, the second pattern 232 and the third pattern 233 are monochrome images having darkness based on the black (K) value.

According to the present invention, the generated monochrome print data may have interlaced patterns to represent a color pixel image. The area ratios and the darkness or density of these patterns are determined by the cyan value, the magenta value, the yellow value and the black value. Thus, each color is represented by a distinct graphical design in the form of black patterns, and the users can easily recognize information on a monochrome printout.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A multi function printer, comprising:
a scanning module reading an image of an original and generating corresponding color image data;
an image processing unit processing the color image data, the image processing unit comprising:
a color converter converting a set of red (R), green (G) and blue (B) values of a pixel of the color image data into a set of cyan (C), magenta (M) and yellow (Y) values, and converting one of the two sets of red (R), green (G) and blue (B) values and cyan (C), magenta (M) and yellow (Y) values into a black (K) value; and
a pattern generator generating a first pattern, a second pattern and a third pattern according to the cyan (C) value, magenta (M) value and yellow (Y) value, respectively;
a print data generator processing the first pattern, the second pattern, the third pattern and the black (K) value into print data; and
a printing module receiving the print data and printing the first pattern, the second pattern and the third pattern of the print data on a medium in a superimposed manner, wherein the patterns are monochrome images having darkness based on the black (K) value.

2. The multi-function printer according to claim 1, wherein the color converter comprises:
a CMY converter converting the set of red (R), green (G) and blue (B) values into the set of cyan (C), magenta (M) and yellow (Y) values; and
a K converter converting the set of cyan (C), magenta (M) and yellow (Y) values into the black (K) value.

3. The multi-function printer according to claim 1, wherein the color converter comprises:
a CMY converter converting the set of red (R), green (G) and blue (B) values into the set of cyan (C), magenta (M) and yellow (Y) values; and
a K converter converting the set of red (R), green (G) and blue (B) values into the black (K) value.

4. The multi-function printer according to claim 1, wherein the pattern generator determines a first area ratio of the first pattern, a second area ratio of the second pattern and a third area ratio of the third pattern according to the cyan (C) value, the magenta (M) value and the yellow (Y) value, respectively, and generates the first pattern with the first area ratio, the second pattern with the second area ratio and the third pattern with the third area ratio.

5. The multi-function printer according to claim 4, wherein the first area ratio, second area ratio and third area ratio are proportional to the cyan (C) value, the magenta (M) value and the yellow (Y) value, respectively.

6. The multi-function printer according to claim 1, wherein each of the first pattern, the second pattern and the third pattern comprises a distinct graphical design.

7. The multi-function printer according to claim 6, wherein the first pattern, the second pattern and the third pattern comprise three sets of parallel straight lines extending in different directions.

8. The multi-function printer according to claim 1, further comprising:
a pattern database storing data corresponding to the patterns, wherein the pattern generator generates the first pattern, the second pattern and the third pattern according to the data of the pattern database.

9. A method of processing color image data into print data, the method comprising the steps of:
(a) converting a set of red (R), green (G) and blue (B) values of a pixel of the color image data into a set of cyan (C), magenta (M) and yellow (Y) values;
(b) converting one of the two sets of red (R), green (G) and blue (B) values and cyan (C), magenta (M) and yellow (Y) values into a black (K) value;
(c) generating a first pattern, a second pattern and a third pattern according to the cyan (C) value, magenta (M) value and yellow (Y) value, respectively; and
(d) processing the first pattern, the second pattern, the third pattern and the black (K) value into the print data.

10. The method according to claim 9 further comprising the step of:
(e) printing the first pattern, the second pattern and the third pattern on a medium in a superimposed manner, wherein the patterns are monochrome images having darkness based on the black (K) value.

11. The method according to claim 9, wherein the step (c) comprises:
determining a first area ratio of the first pattern, a second area ratio of the second pattern and a third area ratio of the third pattern according to the cyan (C), magenta (M) and yellow (Y) values, respectively; and
generating the first pattern with the first area ratio, the second pattern with the second area ratio and the third pattern with the third area ratio.
